(19) United States
(12) Patent Application Publication
(10) Pub. No.: US 2006/0036766 A1
(43) Pub. Date: Feb. 16, 2006

(54) Method and system for managing identity overload and private/public availability of an instant messaging address

(76) Inventors: Nicolas Baupin, Ranville (FR); Anthony Dauguet, Saint Pierre Du Fresne (FR); Mohamed Arkate, Caen (FR)

Correspondence Address: YOUNG & THOMPSON, 745 SOUTH 23RD STREET, 2ND FLOOR, ARLINGTON, VA, 22202, US

(21) Appl. No.: 11/185,939

(22) Filed: Jul. 21, 2005

(30) Foreign Application Priority Data
Jul. 21, 2004 (FR) 0408094

(51) Int. Cl. G06F 15/16

(52) U.S. Cl. 709/245

(57) ABSTRACT

A method and system for managing identity overload and the private/public availability of an instant messaging address. For every internal address (Userᵢ@E) in a business network, (A) declaring a generic internal address (Sales@E) in a list of contact addresses and, following transmission (B) by an external client (Ext@X) of a request to the generic internal address (Sales@E), transmitting the request to each internal address (Userᵢ@E) of the group, then upon a reply (D) to this request at the external address (Ext@X) by one of the internal addresses (User₁@E) belonging to the group, transmitting a reply notification to the other internal addresses (User_{j≠1}@E). This allows the other internal addresses (User_{j≠1}@E) to be kept free for any further request which is addressed.

### TECHNICAL FIELD

The invention relates to the technical field of interpersonal email communications by instant messaging.

It applies more particularly to commercial instant messaging services, in particular to the exchange of messages by instant messaging between internal addresses, within a local area network, in communication with client addresses outside this network.

### BACKGROUND TO THE INVENTION

In the prior art, in the exchange of messages by instant messaging between internal addresses within a company and a local area network supplying said company, the users, each holding an internal address, have to declare their presence, by means of their internal address, on an instant messaging server, an IM server, open externally and in the account they wish to use, in addition to their declaration of presence on the internal IM server of the company, with their own identity. This requires the implementation and use of two IM servers simultaneously.

Furthermore, in the aforementioned systems of the prior art, externally visible addresses or contacts have to be linked to the address of a physical person in the company, Sales1 linked to User1 and Sales2 linked to User2, for example.

The object of the present invention is to remedy the disadvantages of the prior art, by further simplifying the implementation by removing one of the IM servers.

In particular, the present invention aims to allow business users having an internal address to declare, with regard to other users, their presence/availability for their internal address to a single IM server, using their own identity or address but only revealing one specific address outside the local area network, and therefore the company, and being able to specify a meaningful address within the context of the company.

Moreover, the present invention aims to provide the possibility of grouping together, within a single externally visible address or contact of a local area network, one or more internal instant messaging addresses capable of being contacted externally by means of the single address.

Moreover, the present invention aims to provide the possibility to every client user holding an internal instant messaging address in a local area network to declare individually, or not, accessibility to any third party external client user outside this local area network.

Moreover, the present invention aims to provide every client user holding an internal instant messaging address in a local area network who declares accessibility to the outside thereof in a form which is distinct from that used internally, said distinct form being meaningful or non-specific, with an identity or address overload function.

Finally, the present invention is, using the aforementioned identity overload process, to associate a declared generic internal contact or address with a group of internal addresses or contacts of the local area network and having the role of an external contact or address and therefore benefiting from advanced contact functionalities using commercial instant messaging of the ACD (Automatic Cell Distribution) type.

### SUMMARY OF THE INVENTION

The noteworthy object of the method and system for managing identity overload and the private/public availability of an internal instant messaging address associated with a business network, according to the present invention, is to allow, from an address translation server, the declaration of a generic internal address to every internal address, said generic internal address being common to a group of separate internal addresses and, upon transmission by an external client user of a request to this declared generic internal address, to transmit this request to the internal address of each group member then, upon transmission of a reply to this request from the internal address of one of the group members, to transmit a reply notification to the internal addresses of the other group members, separate from the internal address of the author of the reply. This allows the internal addresses of the other group members to be available for any new request transmitted to the declared internal address.

The method and the system according to the present invention are used in the management of instant messaging for local area networks, in particular the internal and external flow of instant messaging thereof.

### BRIEF DESCRIPTION OF DRAWINGS

They will be better understood by reading the following description and examining the following drawings, in which:

FIG. 1 shows, by way of illustration, a general flowchart of the principal steps for implementing the method according to the present invention;

FIG. 2a shows, in the form of block diagrams, a specific architecture of a system for managing identity overload and the private/public availability of an instant messaging address according to the subject of the present invention;

FIG. 2b shows, by way of non-limiting example, in the form of function blocks, the architecture of an internal address translation server integrated with the local area network, part of the system according to the present invention;

FIG. 3a shows, by way of illustration, an illustrative time diagram of the step of declaring a generic internal messaging address by a group of client users, each having an internal instant messaging address associated with the local area network and implemented by the address translation server and the system according to the present invention;

FIG. 3b is, by way of illustration, an illustrative time diagram of the steps for internal transmission of the request by the external client user and the notification of the reply to this request to the internal address of every group member client user, distinct from the internal address, from which this reply has been transmitted.

### DESCRIPTION OF PREFERRED EMBODIMENTS

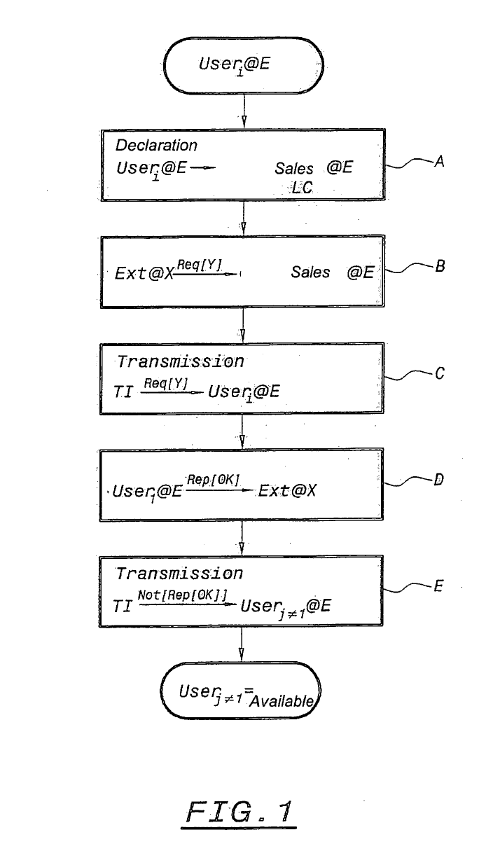

A more detailed description of the method for managing identity overload and the private/public availability of an internal instant messaging address linked to a local area network according to the subject of the present invention will now be given in connection with FIG. 1.

In general terms, a plurality of internal instant messaging addresses referred to as Userᵢ@E are under consideration, where Userᵢ refers to the actual address of the work station of a client user of this local area network and E refers to the company itself or the local network supplying it. All the instant messaging addresses are managed by the conventional procedures for the management of instant messaging addresses, from an instant messaging server, private IM server, in the conventional manner, as mentioned above in the description.

According to the method according to the invention, it consists of one step A for every aforementioned internal address of the business network to declare a generic internal instant messaging address, referred to arbitrarily as Sales@E. This declaration is symbolised by the relationship Userᵢ@E→Sales@E.

It is understood that, by this declaration, each client user of the business network may therefore declare to accept to belong to a group of addresses of which the generic messaging address is the aforementioned business address Sales@E.

Following transmission by an external client, denoted by Ext@X, and the receipt of a request transmitted to the aforementioned declared generic internal instant address, shown at step B by the relationship 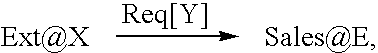
this step is followed by a step C of transmitting the above request to each internal instant messaging address Userᵢ@E. This operation is denoted by 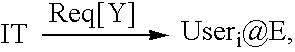
where IT refers to an internal transmission on the local network.

It is naturally understood that at step C the internal transmission IT is carried out on the local network to every Userᵢ address belonging to the group having the generic internal instant messaging address Sales@E.

Upon reply to the request to the client with the external address Ext@X at step D denoted by 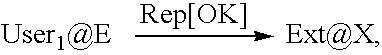
the user User₁ being considered to have accepted to reply, this step is then followed by a step E consisting of the internal transmission IT to the other internal addresses of the group members and distinct from the internal address of the author of the reply, i.e. to the addresses User_{j≠1}@E with a reply notification.

This operation is denoted by

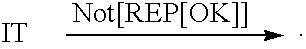

The aforementioned transmission operation allows the other internal addresses, j≠1, to be available for any new request addressed by an external client to the declared generic internal address Sales@E.

Generally, it is shown that the aforementioned generic internal instant messaging address may be advantageously associated with a function, a hierarchical or operational position in the company or, if required, a meaningful or non-specific name. The use of a meaningful name allows, in particular, every external client to have access to the most varied services in the company, irrespective of the identity of the physical person holding the internal messaging address, whilst the use of a non-specific name allows, for example, the network administrator to monitor more easily the exchanges, in particular concerning security as regards illegal access to the corresponding local area network.

It is naturally understood that the declared generic internal address, although the latter is declared as an internal address and therefore managed according to the process of managing the internal instant messaging addresses of the local area network, the declared generic internal messaging address is also seen as an external address, i.e. accessible to every external client user with any external address in the local area network by means of any network or the Internet, for example.

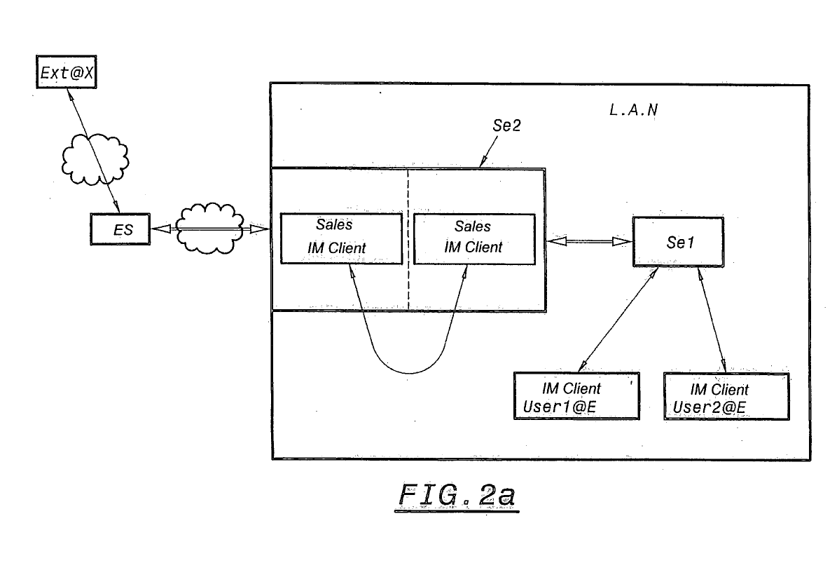

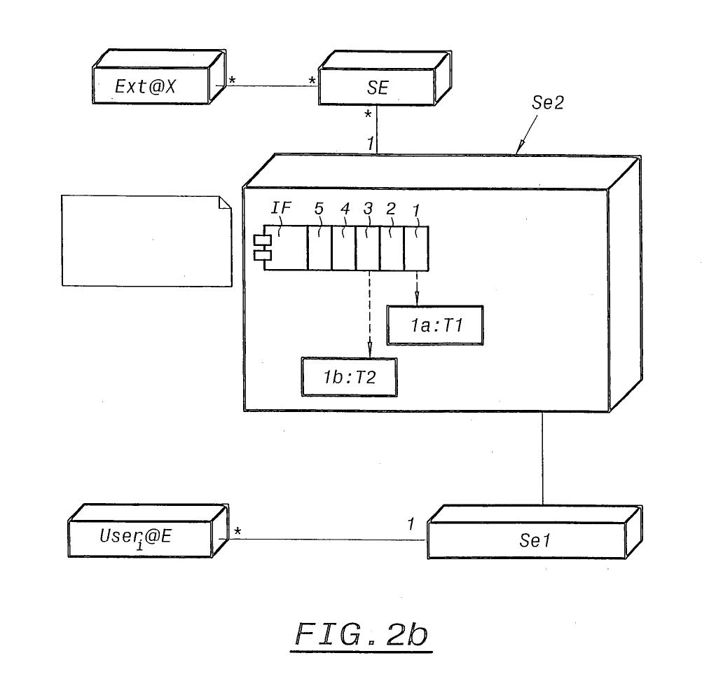

A more detailed description of the system for managing identity overload of the private/public availability of an instant messaging address according to the subject of the present invention will now be given in connection with FIG. 2a and 2b.

The idea of availability to the public covers that of the availability of an internal address outside the local area network with which this internal address is associated.

With reference to FIG. 2a, it will be recalled that the LAN (Local Area Network) comprises, for example, a plurality of work stations, at least one instant messaging internal address Userᵢ@E being associated with each of the users.

Naturally, each work station with the address shown is an instant messaging client, as regards a private instant messaging server Se₁, managing the internal addresses and interconnected to an external instant messaging server ES. The external server ES may be a public server or a private instant messaging server, providing the management of instant messaging for a plurality of business networks, in particular in the case of B2B relations (Business to Business electronic commerce). The latter is connected to the LAN by means of any extended network of the Internet or the like.

The external instant messaging server ES allows an external client user with the address Ext@X to transmit from outside the company, i.e. in every part of any extended network, a request to a specific internal address of the LAN.

As shown in FIG. 2a, moreover, according to one noteworthy aspect of the system according to the present invention, this additionally comprises an address translation server, denoted by Se_{2,} allowing any internal address of an internal user, Userᵢ@E, to declare a generic internal address, i.e. the business address Sales@E mentioned above in the description.

This address is common to a separate group of internal addresses.

In accordance with the implementation of the method according to the invention, as shown in FIG. 1, upon transmission by an external client user of a request to the declared generic internal address Sales@E, the address translation server Se₂ additionally allows the transmission of the request according to the relationship of step C of FIG. 1 to the internal address of each group member, i.e. to all the Userᵢ@E addresses having the declared generic internal address.

Finally, following the transmission of a reply to the request from the external client user with the address Ext@X by one of the internal addresses of the group members, the address translation server Se₂ allows a client user holding this address and taking the initiative to respond to the request of the external client user, to transmit to the internal addresses of the other group members, separately from the internal address of the author of the reply, i.e. a reply notification to the User_{j≠1} addresses according to step E of FIG. 1.

This allows the internal addresses of the other group members to be made available for any new request transmitted to the declared generic internal address.

It is understood, in particular, that maintaining the availability of the User_{j≠1} addresses includes maintaining the availability, provided that the address of these terminals is actually available as regards a similar request from another external client.

In a particularly advantageous manner, the address translation server Se₂ is made up of a proxy instant messaging server interconnected to the LAN.

It will be recalled that the notion of proxy server corresponds to that of a server by proxy having the object of carrying out the aforementioned functions in the description.

The notion of a proxy server actually corresponds to the addition of the aforementioned functions to the private instant messaging server Se₁ in order to allow the carrying out and implementation of the identity overload process and management of visibility and private/public availability mentioned above in the description.

Regarding the roles and/or functions of the aforementioned internal addresses, during the implementation of the method according to the present invention and the functioning of the system according to the present invention, as disclosed in connection with FIG. 1 and 2a, the instructions relative to the aforementioned role are as follows:
Userᵢ@E is seen as an internal instant messaging address of the company internally and is not in any way visible from any point of the extended network outside the LAN.
Sales@E is seen as an internal instant messaging address and is also seen as an external address, in particular by the external instant messaging server ES and naturally by the external client with the address Ext@X.

The external client with the address Ext@x is seen by the address translation server Se₂ as a client with the address Ext@x externally and as a client with the address Sales@E internally by the private instant messaging server Se₁.

Taking into account the above considerations, it is shown that the principal function of the address translation server Se₂ is to mask the identity of the internal client user with the address User₁ and for the address User₁@E only to reveal its function within the company to the outside when the declared generic address corresponds to a function which is common to the group members.

A more detailed description of a preferred embodiment of the address translation server Se₂, according to the present invention will now be given in connection with FIG. 2b.

As shown in the aforementioned FIG. 2b, the address translation server Se₂ comprises, in addition to a conventional type of communication interface IF in the IP network, software or data structure elements allowing all the aforementioned operations to be carried out when a request is addressed by the external client user to the company at the declared generic internal address Sales@E.

These operations relate to carrying out the transmission of the aforementioned request to each internal address, then the reply notification to the internal addresses of the other group members.

As shown in FIG. 2b, the address translation server comprises a module 1 for verifying the availability of the internal address of each group member associated with the declared generic internal address, this module 1, a software module, being associated with a data structure 1a forming a correspondence table and with a data structure 1b corresponding to an identity overload table allowing the following functions and modes of operation to be carried out.

The description which follows is given for the non-limiting case of a first user, denoted by User₁, having the internal address User₁@E and a second user, User₂, having the internal address User₂@E.

The address translation server Se₂ therefore behaves in the manner of a group of clients having a plurality of declared generic internal addresses, such as Sales@E, ProjectManager@E, etc.

Each client having this plurality of generic internal addresses is regarded as a client by the private instant messaging server Se₁ and associated with one or more internal users of the company.

In the example under consideration, the client Sales@E is associated with the group formed by User₁@E and User₂@E. In these conditions, as mentioned above, the latter are seen from the outside as Sales@E and not as their respective internal address.

So that the client, having the address Sales@E, is associated with the addresses User,₁E and User₂@E, it is sufficient for the users thereof to add it to their list of contacts.

The address translation server Se₂ immediately declares the availability of the sales client relative to the external instant messaging server ES and updates a data structure, the structure 1a shown by the following table T₁ and constituting a correspondence table between the identifier of the internal contact User₁ and User₂ and the sales client.

| Client Se₂ | Correspondent |
|---|---|
| Sales | User1 |
| Sales | User2 |
| . | . |
| . | . |
| . | . |

When an external user with the address Ext@X transmits a first message to Sales, i.e. with the generic internal address Sales@E, for example, the address translation server transfers this message by indicating that the sender of the message is at the address Sales@E to all the internal contacts of the company, i.e. to the members of the group who have added the generic sales internal address Sales@E to their contacts.

When one of the internal users, such as for example the client user with the address User₁@E of the company responds to this message, the address translation server transfers the reply to the external user and then sends an alert to the other internal user members of the group who have the address Sales@E as a contact in order to notify them that the request has been dealt with by one of the members of the group, i.e. the member having the address User₁@E.

As soon as the aforementioned notification that the request has been dealt with has taken place, the address translation server constructs a further data structure 1b, shown in the following table T₂, putting the identifiers of the external user, the internal user and the generic internal address in contact, allowing a link between the two so that the following messages of this discussion are only addressed to the internal contact who has responded.

| | | |
|---|---|---|
| External Client | Sales | User₁ |

The above table T₂ indicates that the client user holding the company internal address User₁@E who has subscribed to the declared generic internal address Sales@E and who therefore in this case has the function of a salesperson in the company is in contact with the external client with the address Ext@X.

All the other client users of the company who fulfil the same function as User₁ then receive a message on behalf of the address translation server Se₂ showing them that this client user has dealt with the conversation with the external client.

When a user of the private instant messaging server Se₁ removes from the list of contacts a generic client such as Sales with the address Sales@E, for example, the address translation server Se₂ immediately cancels the availability thereof relative to the external instant messaging server ES, on the one hand, and updates the correspondence table shown as table T₁ , on the other hand.

The above functions are therefore implemented using a software module 1 and the data structures 1a and 1b of FIG. 2b.

The address translation server Se₂ further comprises a module 2, of the software module type, for transmitting via the external instant messaging server ES a request acceptance message to the external client user Ext@X and a module 3, a software transmission module, via the private instant messaging server for the message transmitted by the external client user Ext@X to the generic internal address following verification of availability of the internal address of at least one group member, as mentioned above in the description, associated with the generic internal address, to each of the other available internal addresses of this group. This operation is shown in FIG. 2b by the client terminal Userᵢ with the address Userᵢ@E where i refers to all the members of the group having the declared generic address Sales@E.

Furthermore, the address translation server comprises a receiving module via the private instant messaging server, a software type receiving module 4, for a reply message to the external client user transmitted by the internal address of one of the members of the group, i.e. the client user User1 with the address User₁@E.

The address translation server Se₂ finally comprises a software transmission module 5 for transmitting to the other internal addresses of each of the group members, separately from the internal address of the author of the reply, i.e. transmitting to the client users of the group, each having an address User_{j≠1}, a notification message that the transaction with the external client user with the address Ext@X has been dealt with by the client user having the internal address of the author of the reply.

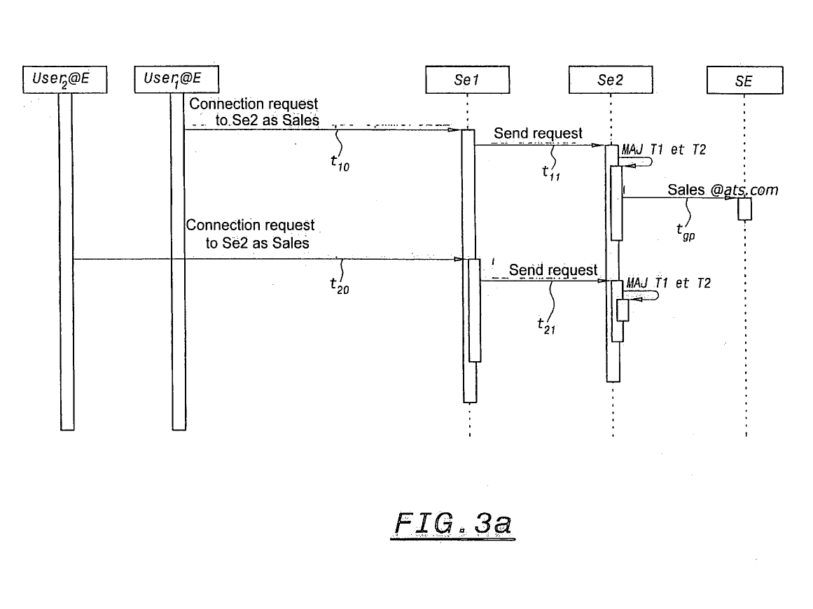

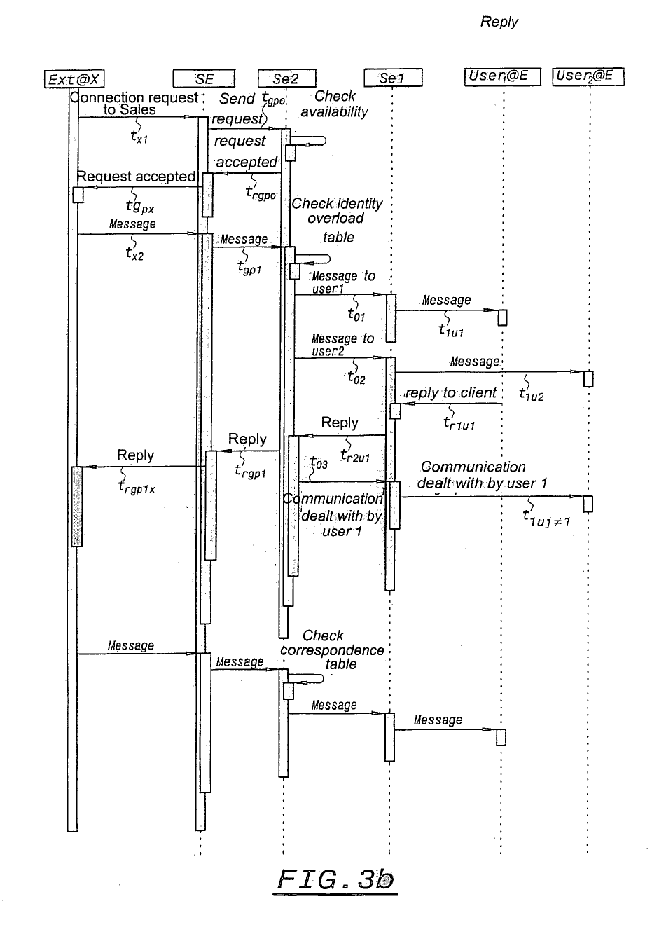

An example of implementing the procedure for exchanging messages to carry out the declaration of a generic instant messaging address by each user having a internal instant messaging address in the company will now be given with reference to FIG. 3a, then an example of the procedure for exchanging messages to carry out internal transmission operations of the request of the external client user and of notification of the reply to this request to the address of all the client user group members will be given in connection with FIG. 3b.

With reference to FIG. 3a, it is shown that, for each internal address for declaring a generic internal address, such as Sales@E by one of the above users, this operation consists at least in addressing, from each internal address on the address translation server Se₂, by means of the private instant messaging server Se₁, a request for declaring the internal generic address, these transmission operations being referred to respectively as t₁₀ and t₂₀ between each user User₁ and User₂ and the private instant messaging server Se₁ respectively t₁₁ and t₂₁between this first server and the address translation server Se₂.

As soon as the messages are received by the above transactions t₁₁ and t₂₁, the address translation server Se₂ proceeds to update the tables, correspondence table and identity overload table, shown in tables T₁ et T₂ described above in the description.

As soon as the above tables are updated, the address translation server Se₂ then proceeds to transmit a notification to the external instant messaging server ES of the notification of the declared generic internal address Sales@E, for example, or any corresponding address indicating that the corresponding declared generic internal address is available in the region of the address translation server Se₂.

In FIG. 3a, the latter address is denoted by Sales@ats.com.

After the transactions carried out in FIG. 3a, it is understood in particular that the system according to the present invention and, in particular, the address translation server Se₂ are totally capable of following up a transaction request transmitted by an external client user with the address Ext@X in the circumstances which will be explained now in connection with FIG. 3b.

With reference to the above figure the external client user, by a transaction tₓ₁, transmits a connection request with the declared generic internal address, i.e. with a view to obtaining the assistance of a person having a sales role.

The transaction tₓ₁ takes place between the terminal of the external client user and the external instant messaging server ES.

The latter transmits a request message via a transaction, denoted by t_{gpo}, to the corresponding address translation server Se₂.

The latter then proceeds to a verification of availability of at least one internal address and of a corresponding user thereof and member of the group.

On receiving a positive reply to this verification, the address translation server Se₂, via a reply request t_{rgpo}, transmits an acceptance message to the server ES.

The latter transmits the same reply via a transaction t_{gpx} to the terminal of the external client with the address Ext@X.

The external client then proceeds to send an information message via a transaction tₓ₂ to the declared generic internal address Sales@E by means of the public instant messaging server PIMS, which relays this transaction via a transaction t_{gp1} to the address translation server Se₂.

As soon as the above transaction is received, the latter proceeds to verify the identity overload table according to table T₂.

After the above verification, the address translation server Se₂ transmits the information message to all the user members of the group, i.e. in the example of FIG. 3b to User₁ and User₂, via respective transactions t₀₁ and t₀₂ by means of the private instant messaging server Se₁, which relays, via transactions to the terminals of the users User1 and User2 with the addresses User₁@E and User₂@E, transactions referred to as t₁ᵤ₁ and t₁ᵤ₂.

When one of the users, User₁ , for example, responds and accepts to communicate with the external user via a transaction tᵣ₁ᵤ₁ transmitted to the private instant messaging server Se₁, the latter relays the above reply via a transaction trᵣ₂ᵤ₁ transmitted to the address translation server Se₂, which carries out the relay of the transmission of the reply via a transaction to the external instant messaging server ES, transaction t_{rgp1}, followed by a further relay via a transaction t_{rgp1x} from the server ES to the client terminal with the address Ext@X.

In turn, the address translation server Se₂ proceeds to the notification that the client communication has been dealt with by the user who has responded to the message, i.e. User1 in the example given, via a transaction t₀₃ transmitted from the address translation server Se₂ to the private instant messaging server Se₁, which relays the transaction t₀₃ by communicating that it has been dealt with by the user and author of the reply via one or more transactions denoted by t_{1uj≠1} for each of the user terminals of which the internal business address is different from that of the user terminal of the author of the reply.

Naturally it is understood that the process may be repeated not only upon a request from a third party external user client, i.e. with an address which is different from that of Ext@X, for the same generic internal address, provided that there are internal instant messaging addresses belonging to the group which are available and indeed available for a transaction or for any separate declared generic internal address, the group of generic addresses declared above being able to cover all the functions and services of the company.

1. Method for managing identity overload and the private/public availability of an instant messaging internal address linked to a local area network, wherein, for any internal address of said local area network, the method consists in:
declaring a generic internal instant messaging address in a list of contact addresses and for every internal address group separate from this local area network having the same declared generic address and forming a group, following the transmission, by an external client, of a request to said declared generic instant internal address,
transmitting said request to each internal instant messaging address belonging to the group, on said local area network, and upon reply to said request to said client with said external address by one of the internal instant messaging addresses belonging to the group,
transmitting to the other internal addresses of the group members, separate from the internal address of the author of the reply, a reply notification which allows said other internal addresses to be available for any new request addressed by an external client to the declared generic internal address.

2. Method according to claim 1, wherein a function, a hierarchical or operational position in the company, a meaningful or non-specific name are associated with said declared generic internal address.

3. System for managing identity overload and the private/public availability of an instant messaging address of a local area network, comprising a plurality of work stations, at least in this local area network, at least one instant messaging internal address being associated with each user of these work stations, a private instant messaging server managing said internal addresses and interconnected to an external instant messaging server, allowing a client user outside the company to transmit a request to a specific internal address, wherein the system further comprises an address translation server, allowing any internal address to:
declare a generic internal address, common to a group of separate internal addresses, and upon transmission by an external client user of a request to said declared generic internal address,
transmit said request to the internal address of each group member, then upon transmission of a reply to said request by one of the internal addresses of the group members,
transmit to the other internal addresses of the group members separate from the internal address of the author of the reply, a reply notification, which allows said other internal addresses of the group members to be available for any new request transmitted to the declared generic internal address.

4. System according to claim 3, wherein said address translation server is formed by an instant messaging proxy server interconnected to the local area network.

5. System according to claim 3, wherein said address translation server comprises at least one correspondence table containing said declared generic internal address and all the internal addresses having declared said generic internal address which is declared and associated therewith to form the group.

6. System according to claim 4, wherein said address translation server comprises at least one correspondence table containing said declared generic internal address and all the internal addresses having declared said generic internal address which is declared and associated therewith to form the group.

7. System according to claim 3, wherein the operation for every internal address for declaring a generic internal address consists in at least:
addressing to said address translation server from each internal address a request to declare the generic internal address by means of the private instant messaging server;
carrying out in the region of said address translation server an update of the correspondence tables via generic internal address;
transmitting to said public instant messaging server the generic internal address(es) as an internal instant messaging address.

8. System according to claim 4, wherein the operation for every internal address for declaring a generic internal address consists in at least:
addressing to said address translation server from each internal address a request to declare the generic internal address by means of the private instant messaging server;
carrying out in the region of said address translation server an update of the correspondence tables via generic internal address;
transmitting to said public instant messaging server the generic internal address(es) as an internal instant messaging address.

9. System according to claim 5, wherein the operation for every internal address for declaring a generic internal address consists in at least:
addressing to said address translation server from each internal address a request to declare the generic internal address by means of the private instant messaging server;
carrying out in the region of said address translation server an update of the correspondence tables via generic internal address;
transmitting to said public instant messaging server the generic internal address(es) as an internal instant messaging address.

10. System according to claim 3, wherein upon receipt of a request addressed by said external client user to the company at said declared generic internal address, for carrying out the transmission of said request to each internal address, then the transmission of the reply notification to the other internal addresses of the group members, said address translation server comprises at least:
means for verifying the availability of the internal address of each group member associated with said declared generic internal address;
means for transmitting, via said external instant messaging server, an acceptance message for said request to said external client user;
means for transmitting, via said private instant messaging server, a message transmitted by the external client user to said internal generic address, following verification of the availability of at least one internal address of the group member associated with said generic internal address, to each of the available internal addresses of this group;
means for receiving, via said private instant messaging server, a reply message to said external client user transmitted by one of said internal addresses of the group members;
means for transmitting to each of the internal addresses of the other group members, separate from the internal address of the author of the reply, a message notifying that the transaction with the external client user has been dealt with via said internal address of the author of the reply.

11. System according to claim 4, wherein upon receipt of a request addressed by said external client user to the company at said declared generic internal address, for carrying out the transmission of said request to each internal address, then the transmission of the reply notification to the other internal addresses of the group members, said address translation server comprises at least:
means for verifying the availability of the internal address of each group member associated with said declared generic internal address;
means for transmitting, via said external instant messaging server, an acceptance message for said request to said external client user;
means for transmitting, via said private instant messaging server, a message transmitted by the external client user to said internal generic address, following verification of the availability of at least one internal address of the group member associated with said generic internal address, to each of the available internal addresses of this group;
means for receiving, via said private instant messaging server, a reply message to said external client user transmitted by one of said internal addresses of the group members;
means for transmitting to each of the internal addresses of the other group members, separate from the internal address of the author of the reply, a message notifying that the transaction with the external client user has been dealt with via said internal address of the author of the reply.

12. System according to claim 5, wherein upon receipt of a request addressed by said external client user to the company at said declared generic internal address, for carrying out the transmission of said request to each internal address, then the transmission of the reply notification to the other internal addresses of the group members, said address translation server comprises at least:
means for verifying the availability of the internal address of each group member associated with said declared generic internal address;
means for transmitting, via said external instant messaging server, an acceptance message for said request to said external client user;
means for transmitting, via said private instant messaging server, a message transmitted by the external client user to said internal generic address, following verification of the availability of at least one internal address of the group member associated with said generic internal address, to each of the available internal addresses of this group;
means for receiving, via said private instant messaging server, a reply message to said external client user transmitted by one of said internal addresses of the group members;
means for transmitting to each of the internal addresses of the other group members, separate from the internal address of the author of the reply, a message notifying that the transaction with the external client user has been dealt with via said internal address of the author of the reply.

13. System according to claim 7, wherein upon receipt of a request addressed by said external client user to the company at said declared generic internal address, for carrying out the transmission of said request to each internal address, then the transmission of the reply notification to the other internal addresses of the group members, said address translation server comprises at least:
means for verifying the availability of the internal address of each group member associated with said declared generic internal address;
means for transmitting, via said external instant messaging server, an acceptance message for said request to said external client user;
means for transmitting, via said private instant messaging server, a message transmitted by the external client user to said internal generic address, following verification of the availability of at least one internal address of the group member associated with said generic internal address, to each of the available internal addresses of this group;
means for receiving, via said private instant messaging server, a reply message to said external client user transmitted by one of said internal addresses of the group members;
means for transmitting to each of the internal addresses of the other group members, separate from the internal address of the author of the reply, a message notifying that the transaction with the external client user has been dealt with via said internal address of the author of the reply.

14. Internal instant messaging address translation server of a local area network, wherein said address translation server formed by an instant messaging proxy server interconnected to said local area network, allows at least every internal address to:
declare a generic internal address, common to a group of separate internal addresses, and upon transmission of a request by an external client user to said declared generic internal address,
transmit said request to the internal address of each group member, then, upon transmission of a reply to said request by the internal address of one of the group members,
transmit to the other internal addresses of the group members separate from the internal address of the author of the reply, a reply notification which allows said internal addresses of the other group members to be available for any new request transmitted to the declared generic internal address.

15. Translation server according to claim 14, wherein said server comprises at least one correspondence table containing said declared generic address and all the internal addresses having declared said generic internal address which is declared and associated therewith to form the group.

16. Computer program product comprising instructions for program coding to implement the steps of the method according to claim 1.

17. Computer program product comprising instructions for program coding to implement the steps of the method according to claim 2.
